(19) United States
(12) Patent Application Publication
(10) Pub. No.: US 2026/0302921 A1
(43) Pub. Date: Oct. 1, 2026

(54) SINGLE-INDUCTOR MULTI-OUTPUT SWITCHING REGULATOR WITH CHARGE CURRENT CONTROL AND RELATED SINGLE-INDUCTOR MULTI-OUTPUT SWITCHING REGULATION METHOD

(71) Applicant: Airoha Technology Corp., Hsinchu City (TW)

(72) Inventors: Kai-Chun Chan, Taoyuan City (TW); Chen-Yu Wang, Hsinchu County (TW)

(73) Assignee: Airoha Technology Corp., Hsinchu City (TW)

(21) Appl. No.: 19/567,385

(22) Filed: Mar. 16, 2026

Related U.S. Application Data
(60) Provisional application No. 63/781,366, filed on Apr. 1, 2025.

(51) Int. Cl. H02M 1/00; H02M 3/158

(52) U.S. Cl. CPC H02M 1/009; H02M 3/158

(57) ABSTRACT

A single-inductor multi-output (SIMO) switching regulator includes an inductor, switch circuits, and a controller circuit. A first switch circuit is coupled between an input voltage node and a first end of the inductor. A second switch circuit is coupled between a reference voltage node and the first end of the inductor. A third switch circuit is coupled between a first output voltage node and a second end of the inductor. A fourth switch circuit is coupled between a second output voltage node and the second end of the inductor. During a first period, the first switch circuit is off, and the second switch circuit is switched on. During a first phase within the first period, the third switch circuit is on, and the fourth switch circuit is off. During a second phase within the first period, the fourth switch circuit is on, and the third switch circuit is off.

### CROSS REFERENCE TO RELATED APPLICATIONS

This application claims the benefit of U.S. Provisional Application No. 63/781,366, filed on Apr. 1, 2025. The content of the application is incorporated herein by reference.

### BACKGROUND OF THE INVENTION

### 1. Field of the Invention

The present disclosure relates to a switching regulator design, and more particularly, to a single-inductor multi-output (SIMO) switching regulator with charge current control and a related SIMO switching regulation method.

### 2. Description of the Prior Art

With advanced development in technology, various electronic products have been presented and are widely used in daily life. In general, a switching regulator is required for providing operating power for an electronic product. The switching regulator may be a buck converter that is capable of converting a high direct current (DC) voltage to a low and stable DC voltage for normal operations of the electronic product. The switching regulator may be designed to adopt one of several conventional control schemes, including a continuous current mode (CCM) control scheme, a discontinuous current mode (DCM) control scheme, a pseudo-CCM (PCCM) control scheme, etc. Among existing multiple-supply implementations, a single-inductor multi-output (SIMO) switching regulator is a very cost-effective solution. The SIMO switching regulator requires only one off-chip inductor and some on-chip power switches. For example, the SIMO switching regulator may supply one output voltage to a light load and one output voltage to a heavy load. However, the SIMO switching regulator may suffer problems resulting from freewheel inductor current used by one control scheme and negative inductor current generated by another control scheme.

### SUMMARY OF THE INVENTION

One of the objectives of the present disclosure is to provide a SIMO switching regulator with charge current control and a related SIMO switching regulation method.

According to a first aspect of the present invention, an exemplary SIMO switching regulator is disclosed. The exemplary SIMO switching regulator includes an inductor, a plurality of switch circuits, and a controller circuit. The inductor has a first end and a second end. The switch circuits include a first switch circuit, a second switch circuit, a third switch circuit, and a fourth switch circuit. The first switch circuit is coupled between an input voltage node and the first end of the inductor. The second switch circuit is coupled between a reference voltage node and the first end of the inductor. The third switch circuit is coupled between a first output voltage node and the second end of the inductor. The fourth switch circuit is coupled between a second output voltage node and the second end of the inductor. The controller circuit is configured to control the plurality of switch circuits. During a first period, the first switch circuit is switched off, and the second switch circuit is switched on. During a first phase within the first period, the third switch circuit is switched on, and the fourth switch circuit is switched off. During a second phase within the first period, the fourth switch circuit is switched on, and the third switch circuit is switched off.

According to a second aspect of the present invention, an exemplary SIMO switching regulation method is disclosed. The exemplary SIMO switching regulation method includes: during a first period, disconnecting an input voltage node from a first end of an inductor, and connecting a reference voltage node to the first end of the inductor; during a first phase within the first period, connecting a first output voltage node to a second end of the inductor, and disconnecting a second output voltage node from the second end of the inductor; and during a second phase within the first period, connecting the second output voltage node to the second end of the inductor, and disconnecting the first output voltage node from the second end of the inductor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a SIMO switching regulator according to an embodiment of the present disclosure.

FIG. 2 is a diagram illustrating a PCCM control scheme managed by a sub-circuit of a controller circuit shown in FIG. 1.

FIG. 3 is a diagram illustrating an ultrasonic-mode regulation that is triggered by a sub-circuit of a controller circuit shown in FIG. 1 after the inductor current is maintained at the freewheel inductor current level by the preceding PCCM control scheme.

FIG. 4 is a diagram illustrating a charge-current-mode regulation that is triggered by a sub-circuit of a controller circuit shown in FIG. 1 after the inductor current is maintained at the freewheel inductor current level by the preceding PCCM control scheme.

FIG. 5 is a diagram illustrating a low-frequency noise scenario in which the charge current control scheme operates when the freewheel inductor current level is not large enough.

FIG. 6 is a diagram illustrating I_{FW}-based selection between the charge current control scheme and the original ultrasonic control scheme according to an embodiment of the present invention.

FIG. 7 is a diagram illustrating an adaptive adjustment of the positive inductor current level according to an embodiment of the present invention.

FIG. 8 is a diagram illustrating an FSM of the charge current control scheme according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

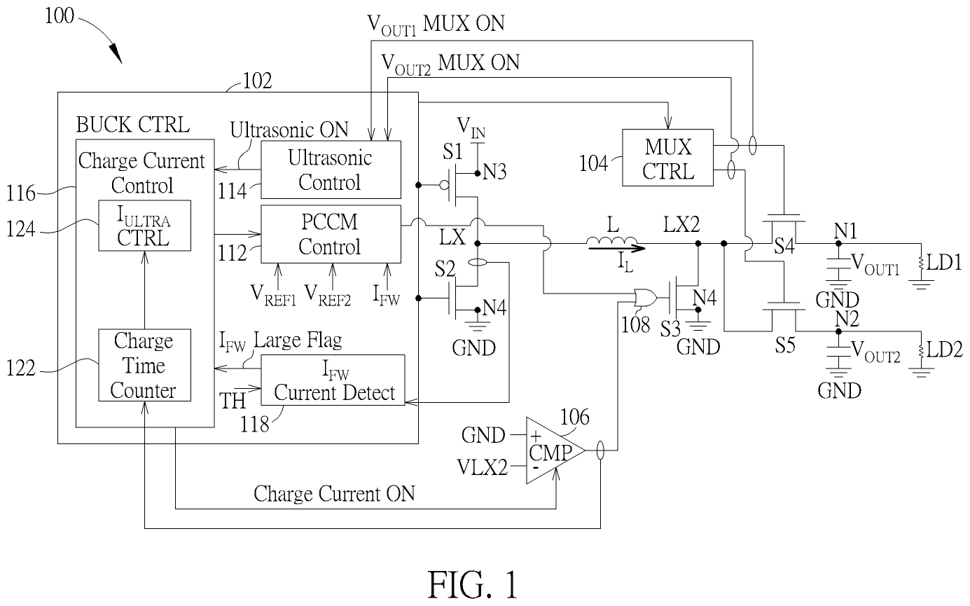

FIG. 1 is a diagram illustrating a SIMO switching regulator according to an embodiment of the present disclosure. The SIMO switching regulator 100 is a voltage converter such as a buck converter. For better comprehension of technical features of the present invention, the following assumes that the SIMO switching regulator 100 is a single-inductor dual-output (SIDO) switching regulator designed for converting an input voltage V_{IN} into two output voltages V_{OUT1} (e.g., V_{OUT1}<V_{IN}) and V_{OUT2} (e.g., V_{OUT2}<V_{IN}). In practice, the SIMO switching regulator 100 may generate more than two output voltages, depending upon actual application requirements. The input voltage V_{IN} may be supplied from a power source such as a battery. An output voltage node N1 of the SIMO switching regulator 100 is coupled to a first load LD1. An output voltage node N2 of the SIMO switching regulator 100 is coupled to a second load LD2. Each of the first load LD1 and the second load LD2 may be any electronic device that consumes electricity.

The SIMO switching regulator 100 includes an inductor L, a plurality of switch circuits S1, S2, S3, S4, S5, a controller circuit (labeled by “BUCK CTRL”) 102, a multiplexer controller (labeled by “MUX CTRL”) 104, a comparator (labeled by “CMP”) 106, and an OR gate 108. The inductor L has a first end LX and a second end LX2. An inductor current I_{L} flowing through the inductor L is defined to have a positive polarity when the inductor current I_{L} flows in a forward direction LX→LX2 that would transfer energy to a load device (e.g., LD1 or LD2). The inductor current I_{L} flowing through the inductor L is defined to have a negative polarity when the inductor current I_{L} flows in a backward direction LX2→LX opposite to the forward direction LX→LX2.

The switch circuits S1, S2, S3, S4, S5 may be implemented using metal-oxide-semiconductor (MOS) switches. The switch circuit S1 is a high-side power switch coupled between an input voltage node N3 and the first end LX of the inductor L, where the input voltage node N3 is configured to receive the input voltage V_{IN} from the power source (e.g., battery). The switch circuit S2 is a low-side power switch coupled between the first end LX of the inductor L and a reference voltage node N4, where the reference voltage node N4 is configured to receive a reference voltage (e.g., ground voltage GND). The switch circuit S3 is a freewheel switch coupled between the second end LX2 of the inductor L and the reference voltage node N4 (which is configured to receive the reference voltage (e.g., ground voltage GND)). The switch circuit S4 is a multiplexer switch coupled between the second end LX2 of the inductor L and the output voltage node N1 (which is configured to provide the output voltage V_{OUT1} to the first load LD1). The switch circuit S5 is a multiplexer switch coupled between the second end LX2 of the inductor L and the output voltage node N2 (which is configured to provide the output voltage V_{OUT2} to the second load LD2). The same inductor L is shared between multiple output voltages V_{OUT1} and V_{OUT1} through the switch circuits S4 and S5. Hence, when the controller circuit 102 instructs the multiplexer controller 104 to make the switch circuit S4 switched on and the switch circuit S5 switched off, the output voltage V_{OUT1} can be regulated through the inductor current I_{L}; and when the controller circuit 102 instructs the multiplexer controller 104 to make the switch circuit S5 switched on and the switch circuit S4 switched off, the output voltage V_{OUT2} can be regulated through the inductor current I_{L}.

The controller circuit 102 is configured to control an ON/OFF state of each of the switch circuits S1-S5 for V_{OUT1}/V_{OUT2} regulation. In this embodiment, the controller circuit 102 supports a plurality of control schemes, including a PCCM control scheme, an ultrasonic control scheme, and a charge current control scheme. Hence, the controller circuit 102 may include a sub-circuit (labeled by “PCCM Control”) 114 for dealing with the PCCM control scheme, a sub-circuit (labeled by “Ultrasonic Control”) 114 for dealing with the ultrasonic control scheme, and a sub-circuit (labeled by “Charge Current Control”) 116 for dealing with the charge current control scheme. The charge current control scheme may be regarded as an improved ultrasonic control scheme, and can be enabled to take the place of the ultrasonic control scheme when certain criteria are met.

In some embodiments of the present invention, the SIMO switching regulator 100 is employed by an audio device such as Bluetooth (BT) earbuds. Selection rules of the control scheme are listed in the following table.

TABLE 1

| | V_{OUT1} | V_{OUT1} |
|---|---|---|
| | (LD1 = Light Load) | (LD1 = Heavy Load) |
| V_{OUT2} | Ultrasonic | Charge Current |
| (LD2 = Light Load) | Control | Control |
| V_{OUT2} | Charge Current | Normal |
| (LD2 = Heavy Load) | Control | Operation (e.g., |
| | | PCCM Control) |

The switching frequency F_{SW} of the SIMO switching regulator 100 is required to be above an audio band (i.e., F_{SW}>20 KHz). When the SIMO switching regulator 100 have two channels both operating under the light load condition, the output voltage drops below the reference voltage less frequently due to inherent characteristics of the light load, and the ultrasonic control scheme can be enabled to regularly trigger regulation of each channel to ensure that each channel has a switching frequency F_{SW} (e.g., F_{SW}=32 KHz) above the audio band. When the SIMO switching regulator 100 have two channels both operating under the heavy load condition, the PCCM control scheme can be enabled to trigger regulation of each channel each time the output voltage is lower than a reference voltage. Due to inherent characteristics of the heavy load, the output voltage drops below the reference voltage more frequently, leading to a higher switching frequency F_{SW} above the audio band. The charge current control scheme is enabled under a condition where one channel operates under light load requiring ultrasonic control, while the other channel operates under heavy load requiring PCCM control.

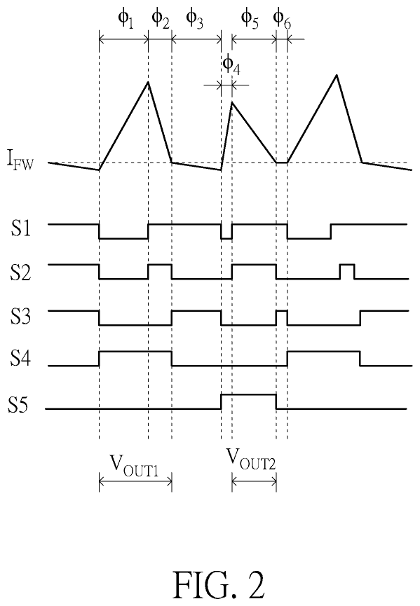

FIG. 2 is a diagram illustrating a PCCM control scheme managed by the sub-circuit 112 of the controller circuit 102. When the output voltage V_{OUT1} is lower than a reference voltage V_{REF1}, the sub-circuit 112 triggers the phase φ₁ by switching on the switch circuits S1, S4 and switching off the switch circuits S2, S3, S5. After an on-time period set by the controller circuit 102 expires, the sub-circuit 112 triggers the phase φ₂ by switching on the switch circuits S2, S4 and switching off the switch circuits S1, S3, S5. After the inductor current I_{L} drops to a freewheel inductor current level I_{FW}, the sub-circuit 112 triggers the phase φ₃ by switching on the switch circuit S3 and switching off the switch circuits S1, S2, S4, S5. The switch circuit S2 is implemented by an N-channel MOS transistor having a body diode with an anode coupled to a source terminal and a cathode coupled to a drain terminal. The positive inductor current I_{L} flows through the inductor L is maintained at the freewheel inductor current level I_{FW} (i.e., I_{L}=I_{FW}) through a loop consisting of the inductor L, the turned-on switch circuit S3, and the body diode of the switch circuit S2.

Similarly, when the output voltage V_{OUT2} is lower than a reference voltage V_{REF2}, the sub-circuit 112 triggers the phase φ₄ by switching on the switch circuits S1, S5 and switching off the switch circuits S2, S3, S4. After an on-time period set by the controller circuit 102 expires, the sub-circuit 112 triggers the phase φ₅ by switching on the switch circuits S2, S5 and switching off the switch circuits S1, S3, S4. After the inductor current I_{L} drops to the freewheel inductor current level I_{FW}, the sub-circuit 112 triggers the phase φ₆ by switching on the switch circuit S3 and switching off the switch circuits S1, S2, S4, S5. The positive inductor current I_{L} flows through the inductor L is maintained at the freewheel inductor current level I_{FW} (i.e., I_{L}=I_{FW}) through the loop consisting of the inductor L, the turned-on switch circuit S3, and the body diode of the switch circuit S2.

The PCCM control scheme differs from a CCM control scheme by adding a High-Z (HiZ) state, and stops the inductor current I_{L} at a high level (i.e., freewheel inductor current level I_{FW}) for a next regulation operation. When the next regulation operation is triggered by the ultrasonic control scheme, there may be problems resulting from the freewheel inductor current maintained by the PCCM control scheme and the negative inductor current generated by the ultrasonic control scheme.

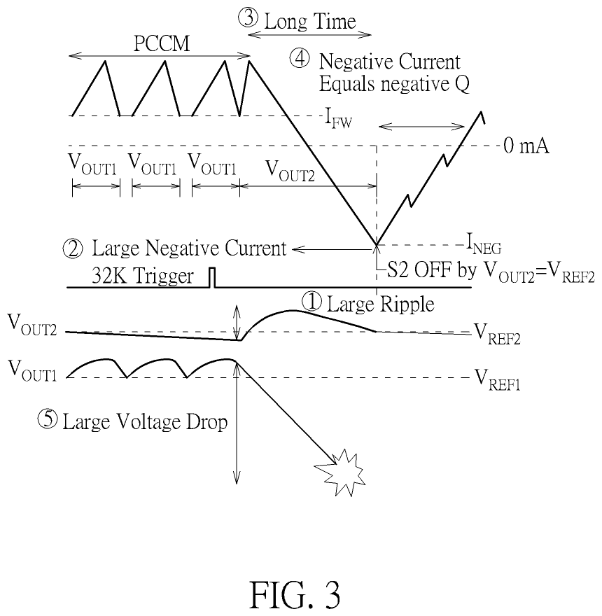

FIG. 3 is a diagram illustrating an ultrasonic-mode regulation that is triggered by the sub-circuit 114 of the controller circuit 102 after the inductor current I_{L} is maintained at the freewheel inductor current level I_{FW} (I_{FW}>0 mA) by the preceding PCCM control scheme. When the ultrasonic control scheme is enabled due to the second load LD2 being a light load, an ultrasonic-mode counter operates to trigger V_{OUT2} regulation at a high frequency (e.g., 32 KHZ) above the audio band. As shown in FIG. 3, V_{OUT2} regulation is triggered during V_{OUT1} regulation under PCCM control. After an end of the current V_{OUT1} regulation, the sub-circuit 114 switches on the switch circuits S1, S5 and switches off the switch circuits S2, S3, S4. After an on-time period set by the controller circuit 102 expires, the sub-circuit 114 switches on the switch circuits S2, S5 and switches off the switch circuits S1, S3, S4. The sub-circuit 114 does not switch off the switch circuit S2 when the inductor current I_{L} drops to a zero current level (i.e., 0 mA), allowing the inductor current I_{L} to reverse its polarity and increase its magnitude. Specifically, the sub-circuit 114 does not switch off the switch circuit S2 until the output voltage V_{OUT2} is equal to the reference voltage V_{REF2}. The negative inductor current is equal to I_{NEG} at the time the output voltage V_{OUT2} is equal to the reference voltage V_{REF2}. The switch circuit S3 is implemented by an N-channel MOS transistor having a body diode with an anode coupled to a source terminal and a cathode coupled to a drain terminal. The switch circuit S1 is implemented by a P-channel MOS transistor having a body diode with an anode coupled to a drain terminal and a cathode coupled to a source terminal. When the switch circuit S2 is switched off, the negative inductor current flows back to the power source (e.g., battery) through the body diode of the switch circuit S3, the inductor L, and the body diode of the switch circuit S1, thereby returning the excess energy (i.e., excess quantity of electric charge Q) to the power source (e.g., battery).

As shown in FIG. 3, the V_{OUT2} regulation starts from a high level (i.e., freewheel inductor current level I_{FW}) maintained by the preceding PCCM control scheme, which makes a peak inductor current has a large magnitude at the time the switch circuit S1 is switched off. As indicated by the circled number 1, a large inductor current will lead to a large ripple of the output voltage V_{OUT2}. In addition, the ultrasonic control scheme will generate a negative inductor current as indicated by the circled number 2, causing the output voltage V_{OUT2} to drop until it reaches the reference voltage V_{REF2}. As indicated by the circled number 3, the operation of driving the inductor current I_{L} to change from the positive peak current to the negative peak current I_{NEG} persists for a long time. Therefore, as indicated by the circled number 4, it takes a long time for the inductor current I_{L} to re-integrate to the freewheel inductor current level I_{FW}. As indicated by the circled number 5, this results in a significant voltage drop for the output voltage V_{OUT1} under heavy load.

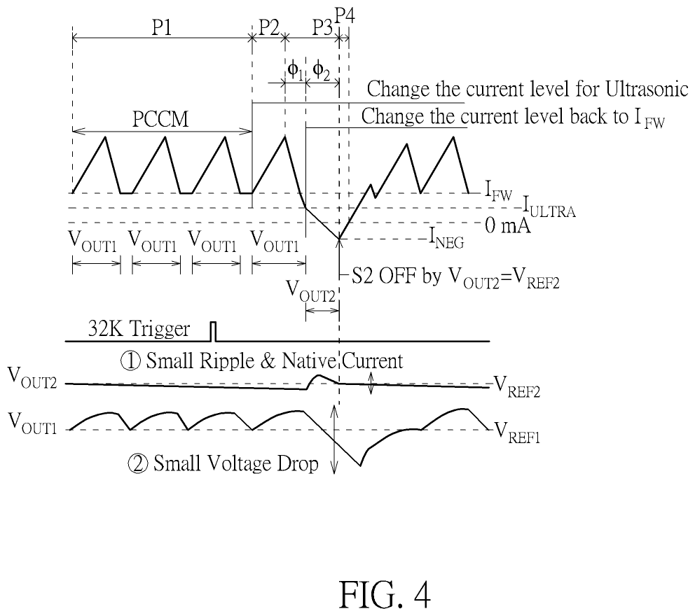

To address above issues, the present invention proposes a new control scheme (i.e., charge current control scheme) which applies adaptive energy distribution to V_{OUT1} regulation and V_{OUT2} regulation. FIG. 4 is a diagram illustrating a charge-current-mode regulation that is triggered by the sub-circuit 116 of the controller circuit 102 after the inductor current I_{L} is maintained at the freewheel inductor current level I_{FW} (I_{FW}>0 mA) by the preceding PCCM control scheme. When the ultrasonic control scheme is enabled due to the second load LD2 being a light load, an ultrasonic-mode counter operates to trigger V_{OUT2} regulation at a high frequency (e.g., 32 KHz) above the audio band. As shown in FIG. 4, V_{OUT2} regulation is triggered during V_{OUT1} regulation under PCCM control (which operates during the period P1). After an end of the period P1, the sub-circuit 116 of the controller circuit 102 activates the charge current control scheme that takes the place of the original ultrasonic control scheme.

During the period P2 following the period P1, the sub-circuit 116 switches on the switch circuits S1, S4 and switches off the switch circuits S2, S3, S5. Hence, energy is first transferred to a channel with a greater power deficit, that is, a channel for supplying an output voltage to a heavy load. In addition, the controller circuit 102 changes an inductor current threshold level from the freewheel inductor current level I_{FW} adopted by PCCM control to a positive inductor current level I_{ULTRA} (0 mA<I_{ULTRA}<I_{FW}) adopted by charge current control. After an on-time period set by the controller circuit 102 expires, the sub-circuit 116 switches on the switch circuit S2 and switch off the switch circuit S1. Specifically, during the period P3 following the period P2, the switch circuit S1 is switched off, and the switch circuit S2 is switched on. In accordance with the proposed charge current control scheme, the period P3 is divided into two phases φ₁ and φ₂. Specifically, switching from phase 1 to phase φ₂ depends on whether the inductor current I_{L} reaches the positive inductor current level I_{ULTRA} (which is intentionally set to be lower than the freewheel inductor current level IF used by the PCCM control scheme). During the phase φ₁ within the period P3, the switching circuits S2, S4 are switched on, and the switching circuits S1, S3, S5 are switched off. Hence, the inductor current I_{L} drops during the phase φ₁ within the period P3. The sub-circuit 116 does not start the following phase φ₂ until the inductor current I_{L} reaches the positive inductor current level I_{ULTRA}. When the inductor current I_{L} drops to the positive inductor current level I_{ULTRA}, the sub-circuit 116 switches off the switch circuit S4, and switches on the switch circuit S5. In addition, since the positive inductor current level I_{ULTRA} is no longer needed by the current regulation operation, the controller circuit 102 changes the inductor current threshold level from the positive inductor current level I_{ULTRA} to the freewheel inductor current level IF used by PCCM control in a next regulation operation.

During the phase φ₂ within the period P3, the switching circuits S2, S5 are switched on, and the switching circuits S1, S3, S4 are switched off. Like the ultrasonic control scheme, the charge current control scheme does not switch off the switch circuit S2 when the inductor current I_{L} drops to a zero current level (i.e., 0 mA), allowing the inductor current I_{L} to reverse its polarity and increase its magnitude. The sub-circuit 116 does not switch off the switch circuit S2 until the output voltage V_{OUT2} is equal to the reference voltage V_{REF2}. The negative inductor current is equal to I_{NEG} at the time the output voltage V_{OUT2} is equal to the reference voltage V_{REF2}. The switch circuit S3 is implemented by an N-channel MOS transistor having a body diode with an anode coupled to a source terminal and a cathode coupled to a drain terminal. The switch circuit S1 is implemented by a P-channel MOS transistor having a body diode with an anode coupled to a drain terminal and a cathode coupled to a source terminal. When the switch circuit S2 is switched off, the negative inductor current flows back to the power source (e.g., battery) through the body diode of the switch circuit S3, the inductor L, and the body diode of the switch circuit S1, thereby returning the excess energy to the power source (e.g., battery) during the period P4. The same ultrasonic effect of V_{OUT1} regulation can be achieved by the proposed charge current control scheme.

The problems encountered in the ultrasonic control scheme are solved or mitigated in the proposed charge current control scheme. As shown in FIG. 4, the V_{OUT2} regulation starts from a lower level (i.e., positive inductor current level I_{ULTRA}), leading to not only a smaller ripple of the output voltage V_{OUT2} (which is indicated by the circled number 1) but also a negative inductor current I_{NEG} with a smaller magnitude. The charge current control scheme generates a negative inductor current, causing the output voltage V_{OUT2} to drop until it reaches the reference voltage V_{REF2}. Since the negative inductor current has a smaller magnitude due to the positive inductor current level I_{ULTRA}, this enables the output voltage V_{OUT1} to start re-integrating the inductor current I_{L} back to the freewheel inductor current level I_{FW} earlier, resulting in a smaller voltage drop for the output voltage V_{OUT1} under heavy load as indicated by the circled number 2.

The freewheel inductor current level I_{FW} may be adaptively adjusted according to variation of the heavy load. For example, the freewheel inductor current level I_{FW} is set by a larger value when the heavy load has an increased load value. For another example, the freewheel inductor current level I_{FW} is set by a smaller value when the heavy load has a decreased load value. If the freewheel inductor current level I_{FW} is not large enough, the charge current control scheme may inject low-frequency noise into the audio band under certain circumstances.

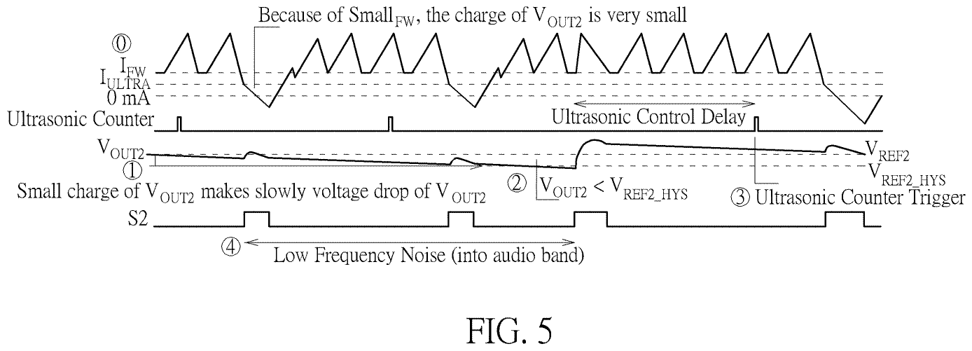

FIG. 5 is a diagram illustrating a low-frequency noise scenario in which the charge current control scheme operates when the freewheel inductor current level I_{FW} is not large enough. As mentioned above, the positive inductor current level I_{ULTRA} is required to be lower than the freewheel inductor current level I_{FW}. If the first load LD2 to which the output voltage V_{OUT1} is supplied is not very heavy, causing the freewheel inductor current level I_{FW} to be very low as indicated by the circled number 0. The electric charge/energy transferred to V_{OUT2} regulation may be minimal, resulting in a slow discharge of the output voltage V_{OUT2} as indicated by the circled number 1. A slow discharge of the output voltage V_{OUT2} makes the output voltage V_{OUT2} drop below a threshold value V_{REF2_HYS}, Causing V_{OUT2} regulation to leave the ultrasonic mode. Subsequently, it will re-enter the ultrasonic mode due to a follow-up trigger of the ultrasonic-mode counter as indicated by the circled number 3. This results in low-frequency noise falling into the audio band as indicated by the circled number 4.

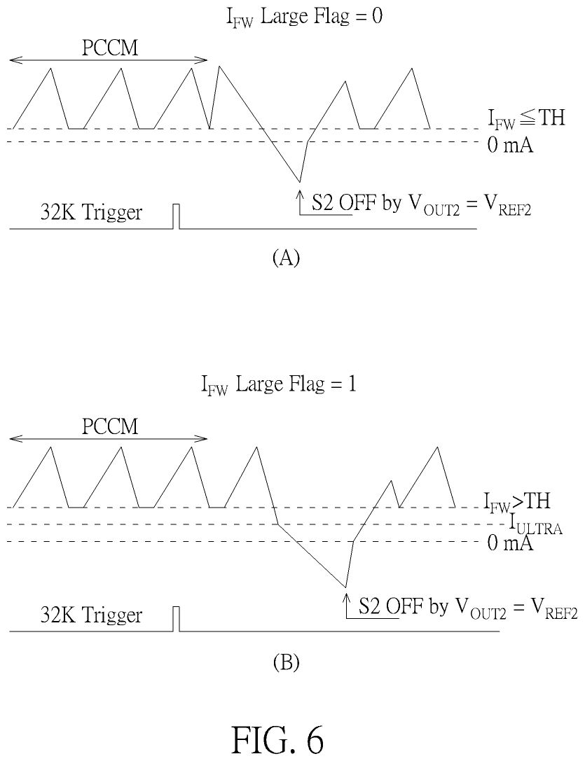

To address the low-frequency noise issue, the controller circuit 102 further includes a sub-circuit (labeled by “I_{FW} Current Detect”) 118 configured to check if the freewheel inductor current level I_{FW} is larger than a pre-defined threshold value TH. If the freewheel inductor current level I_{FW} is larger than the pre-defined threshold value TH, an I_{FW} Large Flag is asserted (i.e., I_{FW} Large Flag=1). If the freewheel inductor current level I_{FW} is not larger than the pre-defined threshold value TH, the I_{FW} Large Flag is deasserted (i.e., I_{FW} Large Flag=0). The I_{FW} Large Flag output from the sub-circuit 118 indicates whether the charge current control scheme should be enabled to act as a substitute of the original ultrasonic control scheme. FIG. 6 is a diagram illustrating I_{FW}-based selection between the charge current control scheme and the original ultrasonic control scheme according to an embodiment of the present invention. It is necessary to ensure a sufficiently large I_{FW} to avoid slow discharge. When the freewheel inductor current level I_{FW} is very small, the original ultrasonic control scheme should be used as illustrated in sub-diagram (A) of FIG. 6. Once the freewheel inductor current level I_{FW} is large enough, the charge current control scheme can be used as illustrated in sub-diagram (B) of FIG. 6.

To avoid slow discharge of the output voltage V_{OUT2} (which is supplied to the second load LD2 being a light load), the charge current control scheme needs to ensure that the charge current can be greater than the maximum load current IMAX ULTRA that can be provided by the charge current control scheme. Consider a case where no negative inductor current is generated under charge current control. The positive inductor current level I_{ULTRA} may be estimated using the following formula.

$${I}_{MAX \_ ULTRA} < \frac{{( {I}_{ULTRA} )}^{2} \times L}{{T}_{ULTRA} \times {V}_{OUT 2}} , where {T}_{ULTRA} = \frac{1}{audio band frequency} \qquad ( 1 )$$

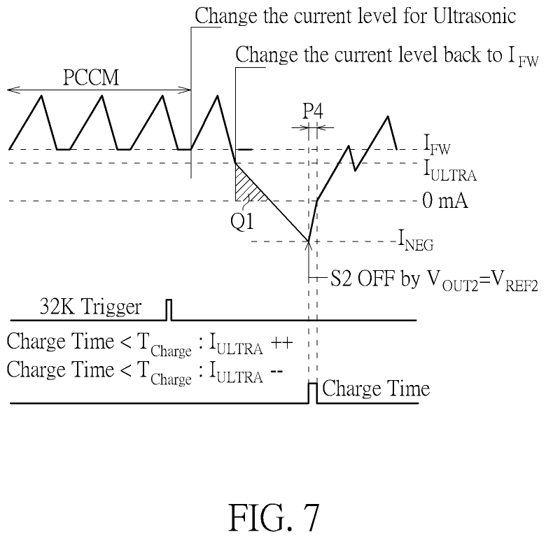

Regarding the embodiment shown in FIG. 4, the charge current control scheme generates a negative inductor current I_{NEG} at the time the switch circuit S2 is switched off in response to V_{OUT2}=V_{REF2}, and then returns the excess energy to the power source (e.g., battery). FIG. 7 is a diagram illustrating an adaptive adjustment of the positive inductor current level I_{ULTRA} according to an embodiment of the present invention. As shown in FIG. 7, if the quantity of electric charge Q1 supplied to the second load LD2 by the positive inductor current I_{L} is sufficient, the charge current control scheme is capable of generating a negative inductor current that is sufficient for driving the output voltage V_{OUT1} to reach the reference voltage V_{REF2}. Specifically, the magnitude of the negative inductor current I_{NEG} is correlated with the setting of the positive inductor current level I_{ULTRA}. In this embodiment, the controller circuit 102 is further configured to adaptively adjust the positive inductor current level I_{ULTRA} according to magnitude of the negative inductor current I_{NEG}, thereby ensuring that the charge current control scheme does not cause slow discharge.

In this embodiment, the sub-circuit 116 may include a charge time counter 122 and an I_{ULTRA} controller (labeled by “I_{ULTRA} CTRL”) 124. The charge time counter 122 is configured to monitor a charge time (i.e., charge time=P4) of charging a voltage V_{LX2} at the second end LX2 of the inductor L from a negative voltage to a zero voltage. The I_{ULTRA} controller 124 is configured to compare the charge time (i.e., charge time=P4) with a reference value T_{Charge} to adaptively adjust the positive inductor current level I_{ULTRA}. The reference value T_{Charge} may be determined using the following formula.

$${T}_{Charge} = \frac{{I}_{NEG} \times L}{{V}_{IN}} \qquad ( 2 )$$

In above formula (2), I_{NEG} can be set by a target value (e.g., 100 mA) which ensures that the charge current control scheme does not cause slow discharge.

As mentioned above, when the switch circuit S2 is switched off, the negative inductor current I_{L} starts flowing back to the power source (e.g., battery) through the body diode of the switch circuit S3, the inductor L, and the body diode of the switch circuit S1, thereby returning the excess energy to the power source (e.g., battery). When there is negative inductor current flowing from the reference voltage (e.g., ground voltage GND) to the input voltage V_{IN}, the voltage V_{LX2} at the second end LX2 of the inductor L has a negative voltage. In this embodiment, the sub-circuit 116 enables the comparator 106 at the time the output voltage V_{OUT2} equals the reference voltage V_{REF2}. Hence, before the voltage V_{LX2} equals the zero voltage, a comparator output of the comparator 106 has a logic high level, and switches on the switch circuit S3 through the OR gate 108. When the voltage V_{LX2} equals the zero voltage, the comparator output of the comparator 106 has a logic low level, and switches off the switch circuit S3 through the OR gate 108. The charge time counter 122 starts counting at the time the comparator output of the comparator 106 has a transition from the logic low level to the logic high level, and stops counting at the time the comparator output of the comparator 106 has a transition from the logic high level to the logic low level.

The duration of the negative voltage V_{LX2} at the second end LX2 of the inductor L (i.e., the charge time measured by the charge time counter 122) can infer how negative the inductor current I_{NEG} is. If the duration is not long enough, it indicates that the positive inductor current level I_{ULTRA} is not high enough, and should be increased by the I_{ULTRA} controller 124. That is, the I_{ULTRA} controller 124 increases the positive inductor current level I_{ULTRA} by an increment value if the charge time output from the charge time counter 122 is shorter than the reference value T_{Charge}. If the duration is too long, it indicates that the positive inductor current level I_{ULTRA} is too high, and should be decreased by the I_{ULTRA} controller 124. That is, the I_{ULTRA} controller 124 decreases the positive inductor current level I_{ULTRA} by a decrement value if the charge time output from the charge time counter 122 is longer than the reference value T_{Charge}. In this way, the positive inductor current level I_{ULTRA} can be adaptively controlled to ensure that the charge current control scheme does not cause slow discharge.

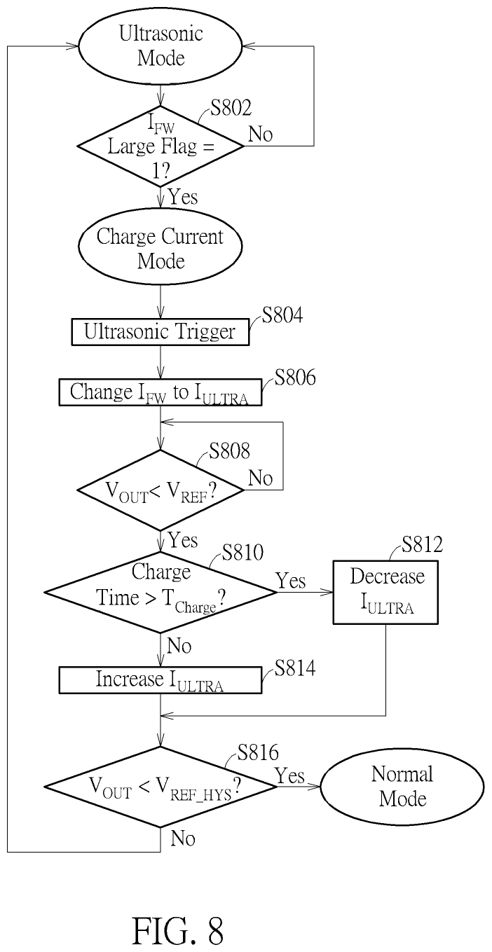

FIG. 8 is a diagram illustrating a finite state machine (FSM) of the charge current control scheme according to an embodiment of the present invention. When the SIMO switching regulator 100 has a first channel for providing a first output voltage (e.g., V_{OUT1}) to a heavy load (e.g., LD1) and a second channel for providing a second output voltage (e.g., V_{OUT2}) to a light load (e.g., LD2), the first channel regulates the first output voltage (e.g., V_{OUT1}) under a normal mode (e.g., PCCM mode), and the second channel regulates the second output voltage (e.g., V_{OUT2}) under an ultrasonic mode. In step S802, the controller circuit 102 checks if the I_{FW} Large Flag is asserted. If the I_{FW} Large Flag is asserted (i.e., I_{FW} Large Flag=1), the controller circuit 102 enables the charge current mode. If the I_{FW} Large Flag is deasserted (i.e., I_{FW} Large Flag=0), the controller circuit 102 keeps regulating the second output voltage (e.g., V_{OUT2}) under the ultrasonic mode. After the charge current mode is enabled to take the place of the ultrasonic mode, the ultrasonic-mode counter triggers regulation of the second output voltage (e.g., V_{OUT2}) during regulation of the first output voltage (e.g., V_{OUT1}) under the PCCM mode (step S804). In step S806, the controller circuit 102 changes the freewheel inductor current level I_{FW} to the positive inductor current level I_{ULTRA} (I_{ULTRA}<I_{FW}). In step S808, the controller circuit 102 checks if an output voltage V_{OUT1} (e.g., V_{OUT}=V_{OUT2}) supplied to a light load (e.g., LD2) is lower than a reference voltage V_{REF} (e.g., V_{REF}=V_{REF2}). If the output voltage V_{OUT1} (e.g., V_{OUT}=V_{OUT2}) is not lower than the reference voltage V_{REF} (e.g., V_{REF}=V_{REF2}), no charge-current-mode regulation operation of the output voltage V_{OUT} (e.g., V_{OUT}=V_{OUT2}) is initiated, and the controller circuit 102 keeps checking if the output voltage V_{OUT1} (e.g., V_{OUT}=V_{OUT2}) is lower than the reference voltage V_{REF} (e.g., V_{REF}=V_{REF2}). If the output voltage V_{OUT1} (e.g., V_{OUT}=V_{OUT2}) is lower than the reference voltage V_{REF} (e.g., V_{REF}=V_{REF2}), the controller circuit 102 initiates a charge-current-mode regulation operation of the output voltage V_{OUT} (e.g., V_{OUT}=V_{OUT2}). In step S810, the controller circuit 102 checks if the charge time is longer than a reference value T_{Charge}. If the charge time is longer than the reference value T_{Charge}, the controller circuit 102 decreases the positive inductor current level I_{ULTRA} that will be used in a next charge-current-mode regulation operation (step S812). If the charge time is shorter than the reference value T_{Charge}, the controller circuit 102 increases the positive inductor current level I_{ULTRA} that will be used in a next charge-current-mode regulation operation (step S814). In step S816, the controller circuit 102 checks if the output voltage V_{OUT1} (e.g., V_{OUT}=V_{OUT2}) supplied to the light load (e.g., LD2) is lower than a threshold value V_{REF_HYS} (e.g., V_{REF_HYS}=V_{REF2_HYS}). If the output voltage V_{OUT1} (e.g., V_{OUT}=V_{OUT2}) is lower than the threshold value V_{REF_HYS} (e.g., V_{REF_HYS}=V_{REF2_HYS}), regulation of the output voltage V_{OUT1} (e.g., V_{OUT}=V_{OUT2}) supplied to the light load (e.g., LD2) leaves the charge current mode and enters the normal mode (e.g., PCCM mode). If the output voltage V_{OUT1} (e.g., V_{OUT}=V_{OUT2}) is not lower than the threshold value V_{REF_HYS} (e.g., V_{REF_HYS}=V_{REF2_HYS}), regulation of the output voltage V_{OUT1} (e.g., V_{OUT}=V_{OUT2}) supplied to the light load (e.g., LD2) leaves the charge current mode and re-enters the ultrasonic mode. It should be noted that FSM shown in FIG. 8 is for illustrative purposes only, and is not meant to be a limitation of the present invention. In practice, any SIMO switching regulator using the proposed charge current control scheme falls within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A single-inductor multi-output (SIMO) switching regulator comprising:
an inductor, having a first end and a second end;
a plurality of switch circuits, comprising:
a first switch circuit, coupled between an input voltage node and the first end of the inductor;
a second switch circuit, coupled between a reference voltage node and the first end of the inductor;
a third switch circuit, coupled between a first output voltage node and the second end of the inductor; and
a fourth switch circuit, coupled between a second output voltage node and the second end of the inductor; and
a controller circuit, configured to control the plurality of switch circuits;
wherein during a first period in which the first switch circuit is switched off and the second switch circuit is switched on:
during a first phase within the first period, the third switch circuit is switched on, and the fourth switch circuit is switched off; and
during a second phase within the first period, the fourth switch circuit is switched on, and the third switch circuit is switched off.

2. The SIMO switching regulator of claim 1, wherein the plurality of switch circuits further comprise:
a fifth switch circuit, coupled between the second end of the inductor and the reference voltage node, wherein the fifth switch circuit is switched off during the first period.

3. The SIMO switching regulator of claim 1, wherein the first output voltage node is coupled to a first load, the second output voltage node is coupled to a second load lower than the first load, and the first phase is followed by the second phase.

4. The SIMO switching regulator of claim 3, wherein during a second period preceding the first period, the first switch circuit and the third switch circuit are switched on, and the second switch circuit and the fourth switch circuit are switched off.

5. The SIMO switching regulator of claim 4, wherein an initial value of an inductor current of the inductor during the second period is set by pseudo continuous conduction mode (PCCM) control of the controller circuit.

6. The SIMO switching regulator of claim 3, wherein the controller circuit is further configured to set a positive inductor current level lower than a freewheel inductor current level adopted by pseudo continuous conduction mode (PCCM) control of the controller circuit, and the second phase starts when an inductor current of the inductor reaches the positive inductor current level.

7. The SIMO switching regulator of claim 6, wherein the controller circuit is further configured to check if the freewheel inductor current level is larger than a threshold value, and enables the first phase and the second phase within the first period when the freewheel inductor current level is larger than the threshold value.

8. The SIMO switching regulator of claim 6, wherein the controller circuit is further configured to adaptively adjust the positive inductor current level.

9. The SIMO switching regulator of claim 8, wherein the plurality of switch circuits further comprise:
a fifth switch circuit, coupled between the second end of the inductor and the reference voltage node;
during a second period following the first period, the second switch circuit and the fourth switch circuit are switched off, and a negative inductor current of the inductor flows through the first switch circuit and the third switch circuit; and
the controller circuit is further configured to monitor a charge time of charging a voltage at the second end of the inductor from a negative voltage to a zero voltage during the second period, and compare the charge time with a reference value to adaptively adjust the positive inductor current level.

10. The SIMO switching regulator of claim 3, wherein during a second period before the first period, a first output voltage at the first output voltage node is regulated under pseudo continuous conduction mode (PCCM) control of the controller circuit, and regulation of a second output voltage at the second output voltage node is triggered by ultrasonic control of the controller circuit;
and the controller circuit enables the first phase and the second phase within the first period in response to the ultrasonic control triggering the regulation of the second output voltage during the second period.

11. A single-inductor multi-output (SIMO) switching regulation method comprising:
during a first period, disconnecting an input voltage node from a first end of an inductor, and connecting a reference voltage node to the first end of the inductor;
during a first phase within the first period, connecting a first output voltage node to a second end of the inductor, and disconnecting a second output voltage node from the second end of the inductor; and
during a second phase within the first period, connecting the second output voltage node to the second end of the inductor, and disconnecting the first output voltage node from the second end of the inductor.

12. The SIMO switching regulation method of claim 11, further comprising:
during the first period, disconnecting the second end of the inductor from the reference voltage node.

13. The SIMO switching regulation method of claim 11, wherein the first output voltage node is coupled to a first load, the second output voltage node is coupled to a second load lower than the first load, and the first phase is followed by the second phase.

14. The SIMO switching regulation method of claim 13, further comprising:
during a second period preceding the first period, connecting the input voltage node to the first end of the inductor, connecting the first output voltage node to the second end of the inductor, disconnecting the reference voltage node from the first end of the inductor, and disconnecting the second output voltage node from the second end of the inductor.

15. The SIMO switching regulation method of claim 14, further comprising:
setting an initial value of an inductor current of the inductor during the second period by pseudo continuous conduction mode (PCCM) control.

16. The SIMO switching regulation method of claim 13, further comprising:
setting a positive inductor current level lower than a freewheel inductor current level adopted by pseudo continuous conduction mode (PCCM) control; and
in response to an inductor current of the inductor reaching the positive inductor current level, starting the second phase.

17. The SIMO switching regulation method of claim 16, further comprising:
checking if the freewheel inductor current level is larger than a threshold value; and
in response to the freewheel inductor current level being larger than the threshold value, enabling the first phase and the second phase within the first period.

18. The SIMO switching regulation method of claim 16, further comprising:
adaptively adjusting the positive inductor current level.

19. The SIMO switching regulation method of claim 18, further comprising:
during a second period following the first period, disconnecting the first end of the inductor from the reference voltage node, disconnecting the second output voltage node from the second end of the inductor, and passing a negative inductor current of the inductor from the reference voltage node to the input voltage node;
wherein adaptively adjusting the positive inductor current level comprises:
monitoring a charge time of charging a voltage at the second end of the inductor from a negative voltage to a zero voltage during the second period; and
comparing the charge time with a reference value to adaptively adjust the positive inductor current level.

20. The SIMO switching regulation method of claim 13, further comprising:
during a second period before the first period, regulating a first output voltage at the first output voltage node under pseudo continuous conduction mode (PCCM) control, and triggering regulation of a second output voltage at the second output voltage node by ultrasonic control; and
in response to the ultrasonic control triggering the regulation of the second output voltage during the second period, enabling the first phase and the second phase within the first period.
